(19) United States
(12) Patent Application Publication
(10) Pub. No.: US 2011/0099120 A1
(43) Pub. Date: Apr. 28, 2011

(54) SYSTEM AND METHOD FOR STORING AND DISTRIBUTING PROFILES

(75) Inventors: Joel Grossman, San Francisco, CA (US); Mitchell Scott Ozer, San Francisco, CA (US); Tasos Roumeliotis, Orinda, CA (US); Jacqueline Allison Bernstein, San Francisco, CA (US); Scott Hotes, Berkeley, CA (US)

(73) Assignee: Wavemarket, Inc., Emeryville, CA (US)

(21) Appl. No.: 12/910,570

(22) Filed: Oct. 22, 2010

Related U.S. Application Data
(60) Provisional application No. 61/361,904, filed on Jul. 6, 2010.
(60) Provisional application No. 61/255,485, filed on Oct. 27, 2009.

(51) Int. Cl. G06Q 99/00

(52) U.S. Cl. 705/325

(57) ABSTRACT

A computer-implemented profile distribution method is provided. The method includes receiving subject-descriptive data associated with a subject and storing the subject-descriptive data. An indication is received of an authorized entity authorized to receive the subject-descriptive data. An access preference indication is received which defines a permission to access to the subject-descriptive data by the authorized entity. A request is received to provide the subject-descriptive data to the authorized entity, and the subject-descriptive data is provided to the authorized entity in response to the request consistent with the access preference indication. A profile distribution system is further provided.

### CROSS REFERENCE TO RELATED APPLICATION(S)

This application claims the benefit of U.S. provisional application No. 61/361,904, filed Jul. 6, 2010 and U.S. provisional application No. 61/255,485, filed Oct. 27, 2009, which are incorporated by reference as if fully set forth.

### BACKGROUND

A common problem today is that in cases of emergency, parents and guardians do not have critical biographical, health, location, historical or other information about a child or adult under their care gathered in one place, nor do they have a way to distribute that information to critical emergency personnel, family members, or others who need to know the information during a particular emergency. Spouses may be similarly challenged in providing useful information to those responding to a particular emergency involving their loved one. Even pet owners may find it difficult to provide persons who might assist with an emergency involving their pet information to facilitate the necessary assistance. For example, a person or pet may become missing or injured and it may be desirable to provide identification or medical information to emergency personnel searching for or providing medical assistance to the person or pet.

Viewed from the perspective of the person who needs to know the information to provide assistance, there is no convenient and expeditious way in the prior art to discover or access critical biographical, health, location, historical or other information about a person or pet who has entered into emergency care or may otherwise require assistance. It would be desirable to conveniently and expeditiously provide access to persons responsible for responding to a particular emergency to critical biographical, health, location, historical or other information about a person or pet requiring assistance.

### SUMMARY

The invention provides a computer-implemented profile distribution method which includes receiving subject-descriptive data associated with a subject and storing the subject-descriptive data. An indication is received of an authorized entity authorized to receive the subject-descriptive data. An access preference indication is received which defines a permission to access to the subject-descriptive data by the authorized entity. A request is received to provide the subject-descriptive data to the authorized entity, and the subject-descriptive data is provided to the authorized entity in response to the request consistent with the access preference indication.

The invention further provides a computer-implemented profile distribution method including receiving subject-descriptive data associated with a subject. An identification code is generated associated with the subject and the identification code is provided to a user for attachment to the subject. A request is received including the identification code from an entity. The subject-descriptive data is provided to the entity in response to receiving the request including the identification code.

The invention further provides a profile distribution system including one or more computing devices including one or more memories including instructions operable to enable the computing devices to perform a procedure. The procedure includes receiving subject-descriptive data associated with a subject and storing the subject-descriptive data. An indication is received of an authorized entity authorized to receive the subject-descriptive data. An access preference indication is received which defines a permission to access to the subject-descriptive data by the authorized entity. A request is received to provide the subject-descriptive data to the authorized entity, and the subject-descriptive data is provided to the authorized entity in response to the request consistent with the access preference indication.

The invention further provides non-transitory computer-readable media tangibly embodying a program of instructions executable by a computing device to implement a method, the computing device being capable of interfacing with a communications network. The method includes receiving subject-descriptive data associated with a subject and storing the subject-descriptive data. An indication is received of an authorized entity authorized to receive the subject-descriptive data. An access preference indication is received which defines a permission to access to the subject-descriptive data by the authorized entity. A request is received to provide the subject-descriptive data to the authorized entity, and the subject-descriptive data is provided to the authorized entity in response to the request consistent with the access preference indication. Herein, non-transitory computer-readable media comprises all computer-readable media except for a transitory, propagating signal.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a schematic illustration of an exemplary operating environment in which a profile distribution system is operable according to a preferred embodiment of the invention.

FIG. 2 is a flow chart showing a computer-implemented method for distributing profile data according to a preferred embodiment of the invention.

FIG. 3 is a flow chart depicting a decision process implemented by a profile distribution system according to a preferred embodiment of the invention.

FIGS. 4-9 are example computer graphic user interface (“GUI”) screen outputs showing features enabled by a system according to a preferred embodiment of the invention.

### DETAILED DESCRIPTION OF THE PREFERRED EMBODIMENT(S)

The preferred embodiments of the invention are described below with reference to the drawing figures where like numerals represent like elements throughout.

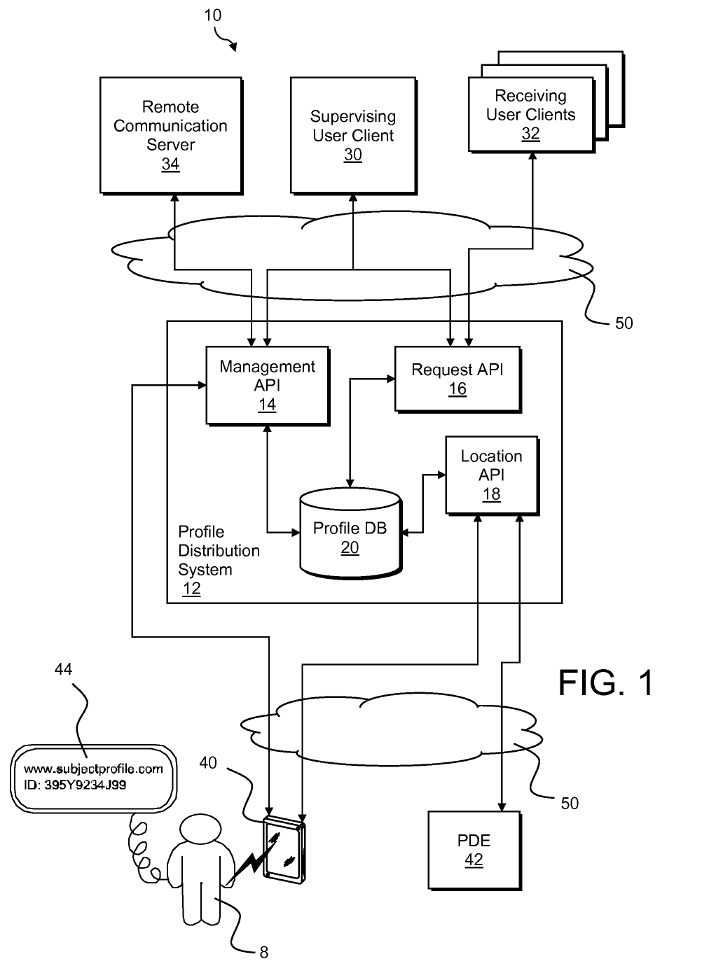

Referring to FIG. 1, a schematic illustration is shown of an exemplary operating environment 10 in which systems according to a preferred embodiment of the invention, including a profile distribution system 12, are shown. Communication flows are represented by arrows between the preferred systems and associated subsystems. The profile distribution system 12 and other components in the exemplary operating environment 10 preferably include one or more computing devices and one or more memory devices, which computing devices and memory devices may be integrally constructed or connected in any suitable manner, for example via a network. The profile distribution system 12 preferably enables a management application program interface (“API”) 14, a profile request API 16, a device location API 18, and a subject profile database 20.

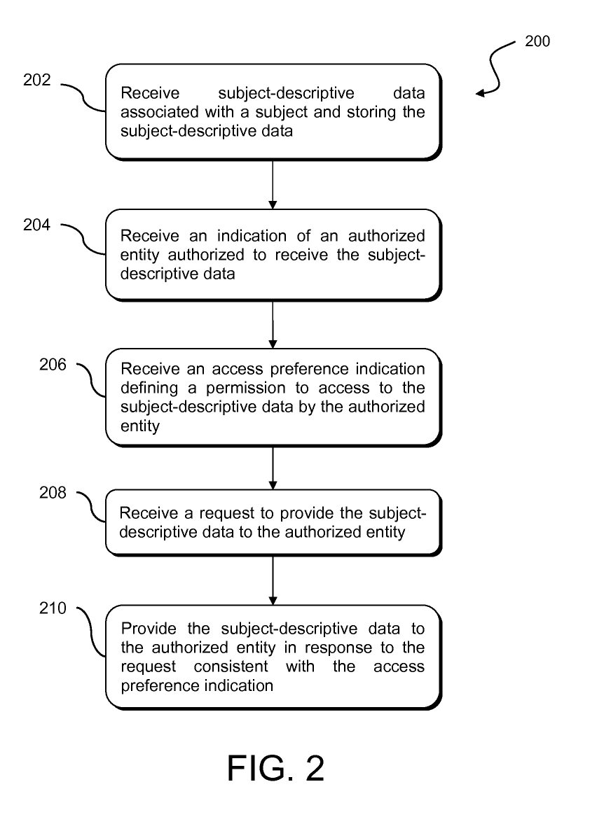

Referring to FIG. 2, a method 200 for distributing profile data is shown. The method 200 is described with reference to the preferred components shown in the operating environment 10 of FIG. 1, including the profile distribution system 12 which preferably includes memory suitable for storing instructions for performance of the method 200. The method 200 may alternatively be performed via other suitable systems. The method 200 includes receiving subject-descriptive data associated with a subject and storing the subject-descriptive data (step 202). The subject preferably includes a child, a pet, or any person or animal which under certain circumstance may require assistance. An indication is received of an authorized entity authorized to receive the subject-descriptive data (step 204), and an access preference indication is received defining a permission to access the subject-descriptive data by the authorized entity (step 206). A request to provide the subject-descriptive data to the authorized entity is received (step 208), and the subject-descriptive data is transmitted to the authorized entity in response to the request consistent with the access preference indication (step 210).

The authorized entity preferably includes any entity, such as emergency response entities, in a position to provide assistance to a subject and authorized pursuant to step 204. Authorized entities can include school administrators, emergency medical responders and call centers, police, good Samaritans, and government-sponsored Public Safety Access Points (“PSAP”), or other entities equipped for providing assistance in a particular environment.

The steps of the method 200 are preferably performed by the profile distribution system 12 or other suitable system or systems via a network 50. The profile distribution system 12 preferably receives one or more of the subject-descriptive data, the indication of an authorized entity, and the access preference indication from a supervising user via a supervising user client 30, which can include any suitable network-connectable computing device. The supervising user preferably includes a parent, guardian or other person with supervisory or oversight responsibility over a particular subject. In the case that the subject is a pet, the supervising user can be a pet owner. Alternatively, one or more of the subject-descriptive data, the indication of an authorized entity, and the access preference indication can be provided by the subject. The authorized entity preferably receives the subject-descriptive data from the profile distribution system 12 via a receiving user client 32, which can include any suitable network-connectable computing device.

The subject-descriptive data can be manually entered or uploaded to the profile distribution system 12 at any suitable time by a supervising user via a supervising user client 30 to create a profile for a particular subject. Alternatively, subject-descriptive data can be automatically gathered via connections to one or more other systems, such as a remote communication server 34, via a network. The subject-descriptive data can alternatively be entered or uploaded by a subject via a suitable client, such as a mobile device 40. Subject-descriptive data is preferably provided to the profile distribution system by the subject or the supervising user via a web or WAP interface. In the case that the subject is a child or otherwise under the care of a supervising user, the supervising user preferably provides the subject-descriptive data.

The remote communication server 34 can include a social networking application server hosting a social networking application enabling an online social network. The profile distribution system 12 via the management API 14 is preferably configured to access and interface with an online social network supported by the social networking application to obtain a subject's subject-descriptive data such as photos, online posts, and communications with others in the social network. The remote communication server 34 can alternatively include a telecommunication carrier communication database as part of a telecommunication carrier infrastructure, wherein the profile distribution system 12 can periodically and automatically gather a subject's communication history including subject telephone call and electronic messaging records corresponding to use by the subject of a mobile telephone device or other communication device. The profile distribution system 12 can further gather a subject's mobile device location history from the subject's mobile device 40, telecommunication carrier infrastructure in communication with the mobile device 40, or other remote network location. Permission is preferably required from a particular subject or an associated supervising user to access the particular subject's subject-descriptive data from a communication server 34, a mobile device 40 or other remote network location.

The profile distribution system 12 preferably communicates with a mobile device, a telecommunication carrier infrastructure in communication with the mobile device, or other network accessible system to receive the mobile device location history and mobile device communication activity history records, which communication records preferably include but are not limited to who the subject communicated with via telephone, email or message service, at what time the subject communicated, and the duration and/or content of the communication. Communication activity history records further preferably include web browsing activity history received from one or more computing devices used by the subject in accessing remote systems via the Internet. Communication activity history records further preferably include recorded social networking application activity including but not limited to who a subject has contacted, called or texted and the time and content of the communication using one or more social networking applications via a network. One or more applications on one or more subject computing devices, including but not limited to a mobile device 40, are preferably configured to transmit web browsing activity and social networking activity of a particular subject to the profile distribution system 12. Alternatively, the communication activity history can include any recordable and transmittable electronic activity of a subject.

The subject-descriptive data preferably includes data for assisting a particular authorized entity with identifying, locating or providing care to a particular subject. The subject-descriptive data can include subject health information, medical history, identifying photographs, contact information, physical description or information regarding a location or recent communications the subject. More specifically, subject-descriptive data can include a subject's name, nickname(s), gender, birth date (age), hair color, eye color, height, weight, distinguishing marks, health conditions, medications, vaccination history, allergies, blood type, picture(s), home address, phone number(s), car make/model/color, license plate number, school address, work or other address, contact information of family, friends, and associates, descriptions of family, friends and associates, recent public or private electronic communications such as electronic text messages, Facebook™ status updates, or Tweets on the Twitter™ online social network, telephone calls, and emails. Information can be entered manually by a subject or supervising user, or determined via a connection to a remote network location, for example an online social network such as Facebook™. If the subject is a pet or animal, the subject-descriptive data can further include a breed identification, indication of name(s) the animal responds to, coat color(s), whether the animal possesses an RFID chip/identifier and the respective identifier number/code, and vaccination records. The profile distribution system 12 is preferably configured to optionally digitally modify subject photographs to perform age progression on subject photos, which may be useful for entities seeking to locate a missing child or adult lost for a long time period.

For both human and pet subjects, the subject-descriptive data of a profile can include a last known location or recent locations of a subject, which can be determined automatically via a device that the subject has with them on their person, around their pet collar, attached to their vehicle or embedded in their affects. Location information can alternatively include network-accessible information that the subject enters with a computing device via text message, web browser, interactive voice response (“IVR”), or a mobile application, for example, a current location inputted by a subject via a social networking application in the form of a “check in” to a particular location for the purpose of notifying others in the subject's social network. In addition to a last known location or recent locations, the profile of a subject can include historical locations from any suitable time period or a listing of commonly visited locations in the form of “favorite places”, which can be determined by algorithmically assessing historical locations obtained automatically from a mobile device or manually from user input.

The subject-descriptive data of a profile can include static or dynamic location information determined via a mobile device 40 associated with a particular subject 8, which mobile device 40 preferably includes a location-aware GPS-enabled mobile telephone or other suitable transmitter/transceiver device which can be possessed by or attached to a subject and is capable of determining its location or enabling another system, such as a position determining entity 42 (“PDE”), to determine its location. The location information is preferably estimated based on a GPS fix of the mobile device 40, a measurement of signals received by the mobile device 40 from one or more cellular base transceiver stations, or a measurement of signals sent by the mobile device 40 to one or more cellular base transceiver stations.

The access preference indication provided by a supervising user or subject preferably includes an indication of what type of subject-descriptive data a particular authorized entity may access and receive. An authorized entity corresponding to a hospital or doctor treating a subject may, for example, be permitted based on the access preference indication to access or receive only health or medical information of the subject, and not permitted to access or receive historical location of the subject. An authorized entity corresponding to a police department searching for a lost or missing subject may, for example, be permitted to access or receive only identifying photographs of the subject, communication history and current or historic location information of the subject, but not medical information. The access preference indication can include an indication of a predetermined time period during which a particular authorized entity recipient can access the subject-descriptive data, after which time period access is denied to the entity. The access preference indication can alternatively include an indication that a particular authorized entity can access any and all subject-descriptive data available for a particular subject at any time for unlimited duration. The preferred embodiment of the invention accordingly enables selective distribution of subject-descriptive data based on recipients' need to know, preventing unnecessary distribution of a subject's personal profile information.

The profile distribution system 12 via the management API 14 preferably enables the setup of a password-protected network-accessible account accessible by a supervising user for creation of a subject profile and management of subject-descriptive data, indications of entities authorized to access subject-descriptive data, and indications of access preferences of authorized entities. The management API 14 preferably enables secure login to such account by a supervising user via a supervising user client 30. The network-accessible account is preferably accessible by the supervising user upon receipt by the profile distribution system 12 of an authorized password and credentials or other authenticating data to ensure substantially secure access to management features of the account. The supervising user preferably has access to all subject-descriptive data. The network-accessible account, via the management API 14, enables receipt by the profile distribution system 12 of the subject-descriptive data, indications of authorized entities, and indications of access preferences from the supervising user. The profile distribution system 12 can receive updates and modifications to the data by a supervising user logged into an associated account. An authorized entity can also be provided with a temporary or permanent account with which to access subject-descriptive data with access preferences set by the supervising user. Subject-descriptive data, indications of entities authorized to access subject-descriptive data, and indications of access preferences are preferably stored in the profile database 20.

A subject can also be enabled to access his/her own profile via his/her own account, for example via a device 40, to make profile changes by contributing and updating subject-descriptive data. Preferably, a supervising user associated with the subject can set account preferences and restrictions for the subject, limiting changes which can be made by the subject.

The subject-descriptive data is preferably provided to the authorized entity through a receiving user client 32 from the profile distribution system 12 in the form of a link, such as a Uniform Resource Locator (“URL”), to a network location where the subject-descriptive data can be accessed, which network location is preferably hosted by the profile distribution system 12. For security, the link is configured to expire after a predetermined time period. Access by authorized entities to the subject-descriptive data at the particular network location is preferably logged by the system 12 to generate an access history log, and a history of the logs by the authorized entities are provided to the supervising user periodically or upon request.

The request (step 208) to provide the subject-descriptive data to a particular authorized entity can originate from a supervising user using a supervising user client 30, wherein subject-descriptive data can be pushed by the supervising user to a receiving user client 32 of an authorized entity. The supervising user preferably logs into a preferably web based account enabled by the profile request API 16 to select a suitable method for providing an authorized entity recipient with subject-descriptive data in the form of a subject profile. Alternatively, the request can originate from a subject via a mobile device 40 or other client system. In a preferred embodiment of the invention, the request can include an indication of an emergency situation received by the profile distribution system 12 including an indication that the subject is missing or lost. Such indication is preferably provided by a supervising user via a web or WAP interface or any suitable communication method, including but not limited to email and telephone. In such case, the authorized entity to receive the subject-descriptive data is preferably an emergency response entity including a police department or other government or private entity enabled to search for missing persons. Alternatively, the request to provide the subject-descriptive data can include an indication of an emergency situation including an indication that the subject is hurt or sick. In such case, the authorized entity to receive the subject-descriptive data is preferably an emergency response entity such as a doctor or hospital responsible for treatment of the hurt or sick subject.

Subject-descriptive data is preferably pushed by the profile distribution system 12 to an authorized entity as an email, fax, FTP or other electronic communication type including the subject-descriptive data as a file in a common document format, for example MS Word™, Adobe Acrobat™, XML, or more preferably as a link, such as a URL, to a file or interface at a network location. The link is preferably an expiring unique URL. The benefit of such expiring unique URL is the data is only accessible for a predetermined, preferably short, period of time, and after that time, which is preferably configurable by the supervising user, the URL no longer accesses the subject profile information. This allows the subject-descriptive data to be shared in case of emergency or other event but thereafter automatically re-locked to prevent access by anyone snooping through email, or even by the original recipient at a later time when access is no longer appropriate. The profile distribution system 12 preferably creates a new unique URL each time a profile including subject-descriptive data is pushed to a recipient. Access by authorized entities via URL or other link is preferably logged in a history and viewable by the associated supervising user. Logging preferably includes the time and date an entity accessed the profile, the email address of the recipient to whom the URL was sent, the IP address from which the access occurred, and any other appropriate logging information to assist in the identification of the persons viewing the profile.

The request (step 208) to provide the subject-descriptive data to a particular authorized entity can alternatively originate from the particular authorized entity using a receiving user client 32, wherein subject-descriptive data can be pulled by the particular authorized entity. Accordingly, an authorized entity can retrieve the subject-descriptive data profile content via the profile request API 16 without a supervising user, subject or other entity explicitly pushing it to the authorized entity. An authorized entity of the information is preferably enabled to search a profile based on any identifying subject-descriptive data such as a subject's name, phone number, email address or any suitable identifiable attribute. The authorized entity is preferably enabled to search the profile database 20 for subject-descriptive data of subjects for which it is authorized. With permission of the supervising user, or alternatively the subject, authorized entities are preferably pre-certified to have privileged access to profile content, which entities can include for example a government-sponsored Public Safety Access Point (PSAP) or 911 emergency call center.

The authorized entity is enabled to access the profile distribution system 12 with unique credentials which identify the authorized entity and a system, such as the receiving user client 32, from which the authorized entity accesses the profile distribution system 12. For example, an agent or employee of the PSAP or other trusted entity can obtain a set of unique credentials through the trusted PSAP. These credentials can be set to only allow access for a short window of time, for example an employee or agent's work shift, and/or may specify that the credentials can only be utilized from certain machines/IP addresses, whereby credentials cannot be used from a personal computer or home of such employee or agent. As another access control, the profile distribution system 12 can be optionally configured that the subject profile data is only shared with another authorized machine system, for example a 911 call control system, and is not accessible from a personal computer or via a web interface.

A supervising user or subject via an access preference indication preferably can specify whether particular subject-descriptive data is available for push only, pull only, or push and pull. An access preference indication can further designate different levels of pull authority, wherein for example independently-certified authorities such as 911 call centers and PSAPs have unmitigated access to pull subject-descriptive data, whereas other entities such as a child subject's school nurse would require new authorization from a supervising user to pull subject-descriptive data each time they transmit a request.

The profile distribution system 12 preferably receives from the subject, or the supervising user responsible for oversight of the subject, an indication of a preferred authorized entity, such as an emergency response entity, to which the subject's subject-descriptive data, for example identifying information, location history and communication history, will be transmitted in a particular circumstance. As indicated above, the profile distribution system 12 preferably receives from the subject or supervising user an authorization in the form of an access preference indication to transmit all or selected portions of the subject's subject-descriptive data dependent on the authorized entity to which the subject-descriptive data will be transmitted. The request to provide the subject-descriptive data (step 208) can include an indication of a particular emergency situation, wherein a subject's subject-descriptive data is provided to the one or more particular authorized entities associated with the type of emergency situation in response to the request consistent with the access preference indication for the particular authorized entities. For example, a request from a supervising user can include an indication that a particular subject is lost, which emergency situation corresponds to authorized entities including a police department, which police department is provided with identifying photographs of the subject, communication history and current or historic location information of the subject, but not medical information. As another example, a request from a supervising user can include an indication that a particular subject is having a health emergency, which emergency situation corresponds to an authorized entity including a local hospital, which hospital is provided with identifying photographs of the subject, current location information of the subject, and medical information, which provided information is consistent with the access preferences specified by the supervising user for the hospital. Alternatively, access preference indications can be associated with a particular emergency situation, wherein an access preference associated with a particular authorized entity is dependent on what type of emergency situation is indicated, and subject-descriptive data associated with the access preference corresponding to the particular emergency situation is provided to the authorized entity.

Generally for security, the profile distribution system 12 is preferably configured to receive and validate credentials along with a login password from any party requesting the subject-descriptive data as a condition for permitting access to the subject-descriptive data. The profile distribution system 12 is preferably configured to optionally determine if a request to provide subject-descriptive data originates from an authorized machine, for example defined by MAC address, or alternatively an authorized Internet Protocol (“IP”) address. Permitting access to the subject-descriptive data is preferably conditional on receiving the request from an authorized machine or authorized IP address. The credentials, the authorized machine, and authorized IP address can correspond to the supervising user client 30, for a request received from the supervising user, or the receiving user client 32, for a request received from the authorized entity. Preferably, the profile distribution system 12 provides the subject-descriptive data as a profile to an authorized entity in response to receiving the request, the validated credentials and login password from an authorized machine and/or an authorized IP address. The authorized machine or authorized IP address can be associated with a PSAP or other public or private entity responsible for public safety in a particular area. The credentials are preferably optionally configured to have an expiration time after which they cannot be validated, whereby access of the subject-descriptive data is granted for a predetermined period of time. In such manner, the chance is reduced for subject-descriptive data to be accessed by unauthorized entities or become publicly distributed.

In a circumstance in which the subject-descriptive data is requested by an untrusted entity which is not authorized to receive the data, the profile distribution system 12 preferably provides an indication of the request to the supervising user via the supervising user client 30. The profile distribution system 12 preferably notifies the supervising user of the request in the form of a message such as an email, SMS, or other suitable electronic messaging protocol to the supervising user client 30 or other suitable network accessible computer. The profile distribution system 12 thereafter receives from the supervising user an authorization of the previously unauthorized entity, converting the unauthorized entity to an authorized entity. The profile distribution system 12 thereafter provides the subject-descriptive data as a subject profile to the newly authorized entity via a receiving user client 32 or other suitable network accessible computer. Alternatively, the profile distribution system 12 receives a denial of authorization from the supervising user and can transmit an indication of such denial to the untrusted unauthorized entity. Accordingly, a supervising user can, on a case-by-case basis, grant access to a particular entity which has not been pre-authorized or has expired credentials, for example a subject's school nurse or a PSAP without current software upgrades to enable authorized access.

The profile distribution system 12 further preferably enables a web or other suitable interface via the Internet for unauthorized entities to contact and request a profile including subject-descriptive data of a particular subject. A particular untrusted, unauthorized entity may be unaware of how to contact the profile distribution system 12 via such web interface or other interface, especially in the case that the existence of the system 12 is not particularly well known. The profile distribution system 12 is preferably configured to generate a unique profile identification code associated with a subject and to provide the profile identification code to a supervising user via a supervising user client 30 or other suitable vehicle. A supervising user can thereafter provide the profile identification code to the subject on media, such as a tag 44, which can be carried or physically attached to the subject. The media can include memory within a mobile communication device or radio frequency identification (“RFID”) device for transmitting an RFID code. The media can further include a stamped or printed visible code, which can be carried on a card, tag or other readily observable indicator. If a subject possessing the media is lost or incapacitated, an assisting person or other entity can read or access the identification code and transmit the identification code to the profile distribution system 12 as a credential for authentication to request and receive subject-descriptive data which may be necessary to provide assistance to the subject.

The media can include, for example, a child/pet/human-wearable message such as a paper/plastic bracelet, or sticker, that a good Samaritan or other assisting entity, such as a school administrator, an emergency medical responder, the police, may see upon finding a subject person/pet subject in distress. This message can include a Uniform Resource Locator (“URL”), or alternatively another suitable network location indication, and the unique profile identification code for the subject. An assisting unauthorized entity can access the URL and enter the subject's unique profile identification code along with the assisting unauthorized entity's email address and/or mobile phone number. When that code is submitted by the assisting unauthorized entity, the supervising user of the subject profile is notified that the assisting entity has requested to access the subject's profile, and the identifying email address and phone number of the assisting entity is provided to the supervising user. The supervising user or designee of the supervising user must authorize access by the assisting entity to the profile including subject-descriptive data. Once authorization is given, the profile distribution system 12 preferably transmits via email, text message, or other suitable electronic communication a new, expiring unique code or URL to the assisting entity to be used for access to the profile. This new code is a preferably for one-time or limited-time use and expires so it cannot be shared or used later to prevent unauthorized persons from accessing a subject's profile. Alternatively, if a profile identification code is submitted by an authenticated authorized entity in a request to the profile distribution system 12, for example via a network accessible account which the authorized entity logs into with an appropriate password and/or credentials, subject-descriptive data is preferably provided to the authorized entity as a profile without further authorization from a supervising user. In such manner, a particular entity with an appropriately configured account which a supervising user pre-authorizes to obtain subject-descriptive data, for example a school administrator, emergency medical response entity, police department, or government-sponsored PSAP, can access a particular subject's profile with the unique profile identification code, and without additional information regarding the subject or additional authorization from a supervising user.

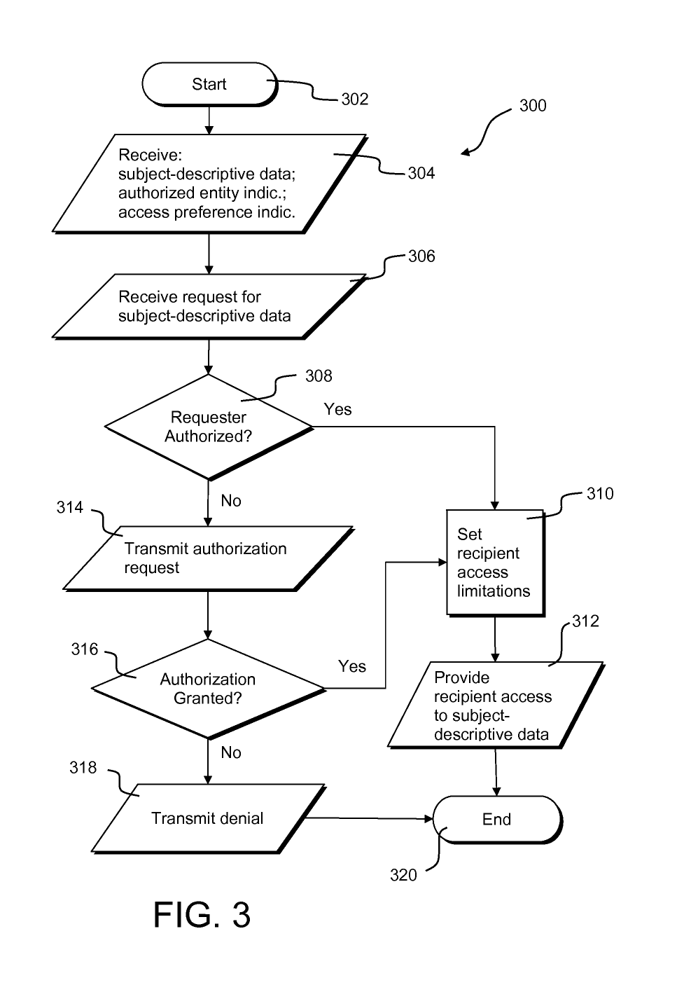

Referring to FIG. 3, a flow chart is shown depicting a decision process 300 implemented by a profile distribution system 12 according to a preferred embodiment of the invention. The process 300 starts (step 302), and subject-descriptive data of a subject, authorized entity indications including indications of entities permitted to receive the subject-descriptive data, and an access preference indication which define a permission to access to the subject-descriptive data by an authorized entity (step 304), which information is preferably provided by a supervising user responsible for oversight of the subject. A request for the subject-descriptive data is received from a requester (step 306). The request can include a request to receive the subject-descriptive data or a request to provide a particular entity the subject-descriptive data. It is determined if the requester is an authorized entity which is authorized to receive subject-descriptive data or if the requester is a supervising user authorized to provide access to the subject-descriptive data by an authorized entity (step 308). If it is determined that the requester is authorized, access limitations are set for the authorized entity to receive the subject-descriptive data consistent with the access preference indications received (step 310), the subject-descriptive data is provided to the recipient, which is an authorized entity (step 312), and the process ends (step 320). If it is determined that the requester is not an authorized entity authorized to receive the subject-descriptive data, an authorization request is preferably transmitted to the supervising user or entity responsible for the subject (step 314). It is determined if the supervising user or other responsible entity grants authorization to the requester (step 316). If it is determined such authorization is granted, the process proceeds to set recipient access limitations consistent with the access preference indication (step 310), provide the subject-descriptive data to the recipient (step 312), and end (step 320). If it is determined authorization is not granted to the prospective recipient, a denial indication is transmitted to the prospective recipient (step 318) and the process ends (step 320).

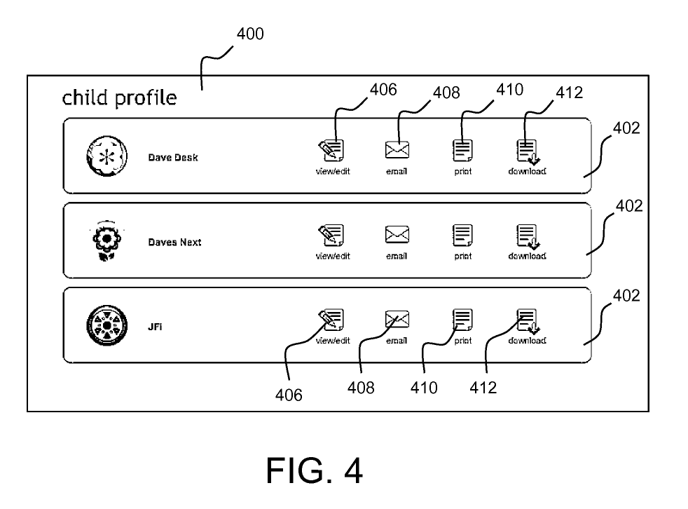

The profile distribution system 12 via the management API 14 and Request API 16 enables computer graphic user interfaces (“GUIs”), preferably via network-accessible websites, useful for implementing the above-described methods according to a preferred embodiment of the invention. Referring to FIGS. 4-9, captures of non-limiting example GUI screen outputs show an abridged set of features enabled by the profile distribution system 12. The example GUI screen outputs of FIGS. 4-9 are representative of curtain, but not all, features enabled by the profile distribution system 12 or the above-described methods according to the preferred embodiments of the invention.

FIG. 4 shows a first user interface 400 in which profile interfaces 402 for three subjects, “Dave Desk”, “Daves Next”, and “JFi” are accessible. The profile interfaces 402 each include a “view/edit” button 406, enabling editing of subject-descriptive data, an “email” button 408, enabling transmission of subject-descriptive data, a “print” button 410, enabling printing of subject-descriptive data, and a “download” button 412, enabling downloading of subject-descriptive data.

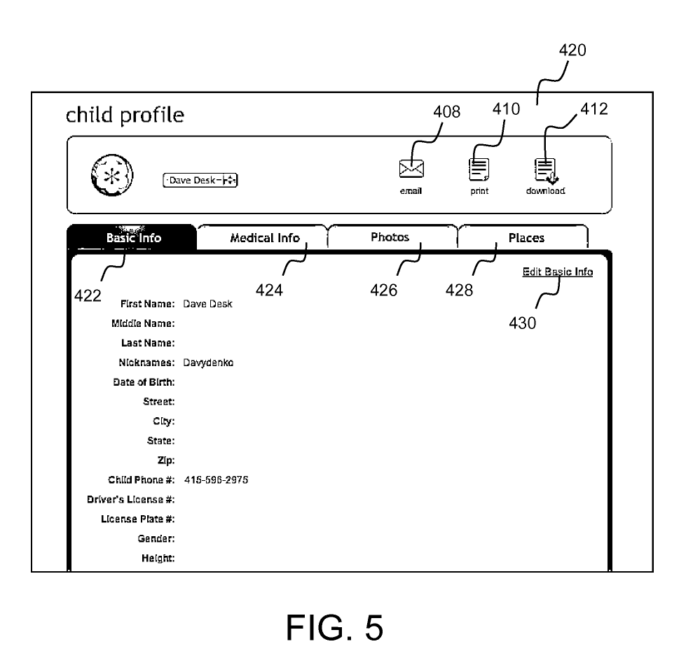

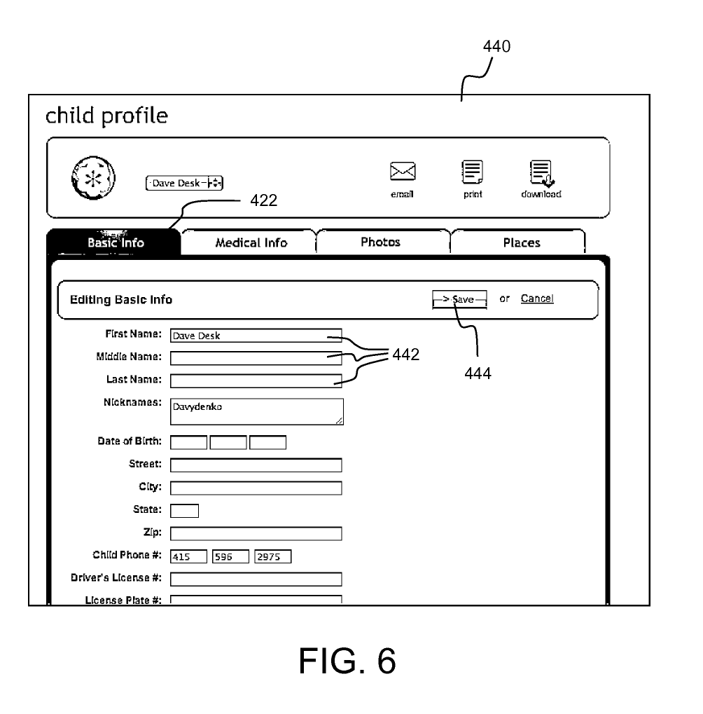

FIG. 5 shows a second user interface 420 generated in response to activating the “view/edit” button 406 of the profile interface of “Dave Desk”. The second user interface 420 enables viewing and editing of subject-descriptive data sorted by a “Basic Info” tab 422, “Medical Info” tab 424, “Photos” tab 426, and “Places” tab 428. Activating an “Edit Basic Info” link 430, permits editing of particular subject-descriptive data as shown in FIG. 6 in a third user interface 440. Fillable fields 442 permit a user, such as the above-described supervising user via a supervising user client 30, to enter subject-descriptive data regarding a particular subject, in this case, “Dave Desk”, which data can be saved by activating a “Save” button 444.

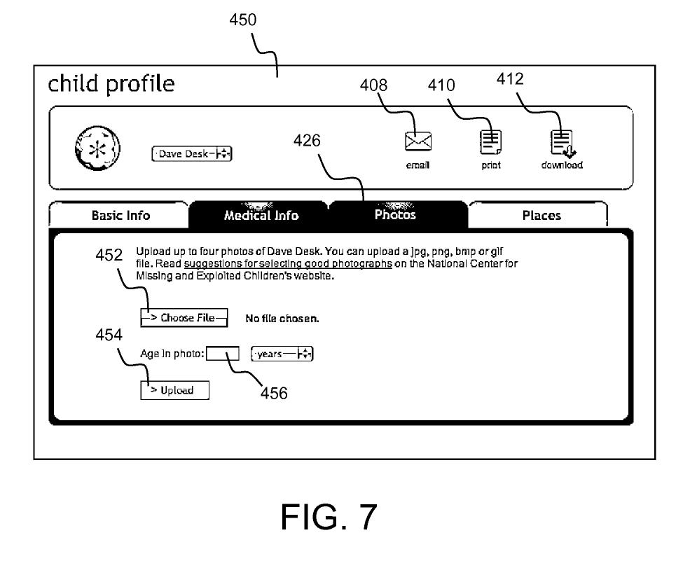

Activating the “Photos” tab 426 enables selection and upload of photographs of a subject-user, as shown in FIG. 7 in a fourth user interface 450. A “Choose File” button 452 permits selection of a photo file for upload to the profile distribution system 12 by activating an “Upload” button 454. The age of the subject-user when the photo was taken can be entered in an “Age in photo:” field 456, which can be helpful to permit age progression photo modification to be performed by a recipient of the photo or the profile distribution system 12.

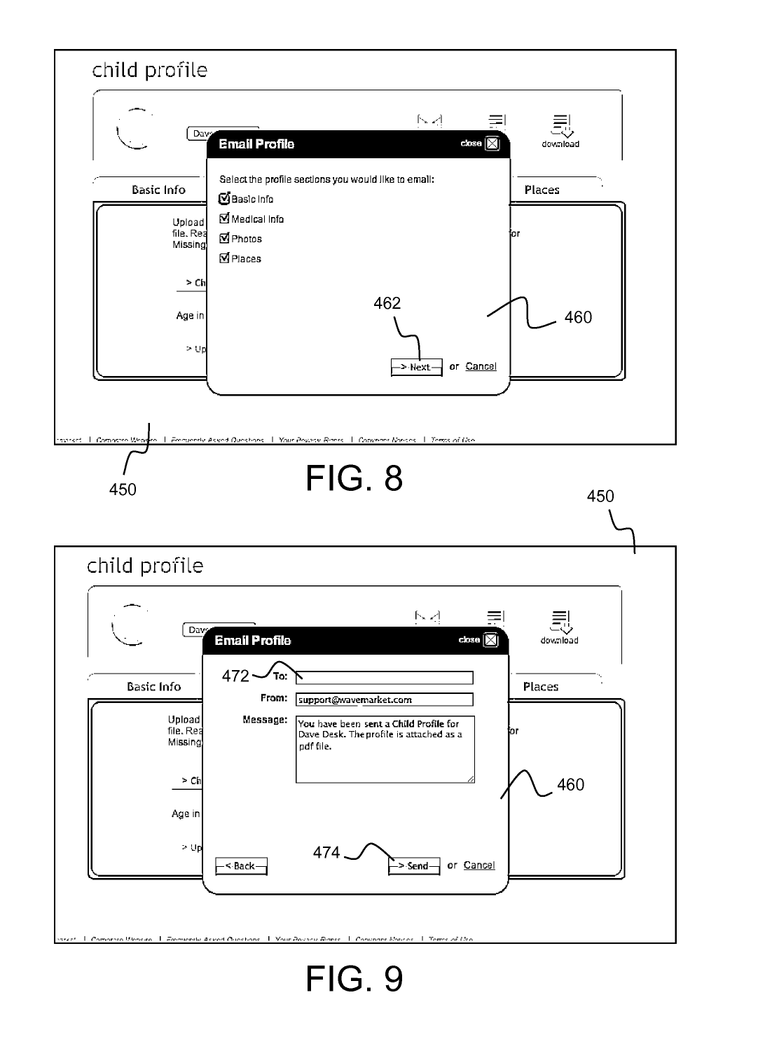

Activating the “email” button 408 enables selection and transmission of a subject-user's subject-descriptive data, as shown in FIG. 8 in a window 460. A user such as a supervising user can select one or more access preference indications including “Basic Info”, “Medical Info”, “Photos”, and “Places” corresponding to respective subject-descriptive data. Activating a “Next” button 462 enables entering a recipient's email address in a “To:” field 472, and activating a “Send” button 474 initiates transmission of the selected subject-descriptive data to the indicated recipient as a profile in an email push process.

While the preferred embodiments of the invention have been described in detail above, the invention is not limited to the specific embodiments described above, which should be considered as merely exemplary. Further modifications and extensions of the invention may be developed, and all such modifications are deemed to be within the scope of the invention as defined by the appended claims.

What is claimed is:

1. A computer-implemented profile distribution method comprising:
receiving subject-descriptive data associated with a subject and storing the subject-descriptive data;
receiving an indication of an authorized entity authorized to receive the subject-descriptive data;
receiving an access preference indication which defines a permission to access to the subject-descriptive data by the authorized entity;
receiving a request to provide the subject-descriptive data to the authorized entity; and
providing the subject-descriptive data to the authorized entity in response to the request consistent with the access preference indication.

2. The computer-implemented method of claim 1, further comprising receiving the subject-descriptive data as at least one of health information, contact information, a physical description and location information of the subject.

3. The computer-implemented method of claim 1, further comprising retrieving the subject-descriptive data from a communication server via a social networking application.

4. The computer-implemented method of claim 1, wherein the subject is an animal, the method further comprising receiving the subject-descriptive data as at least one of a breed identification, a physical description, a license number, and a vaccination history.

5. The computer-implemented method of claim 1, further comprising receiving the subject-descriptive data as a dynamic location of a mobile device associated with the subject, which location is estimated based on at least one of:
a GPS fix of the mobile device associated with the subject;
a measurement of signals received by the mobile device from a base transceiver station; and
a measurement of signals sent by the mobile device to a base transceiver station.

6. The computer-implemented method of claim 1, further comprising:
providing an application program interface (“API”) permitting substantially secure login by a user;
receiving the subject-descriptive data via the API from the user; and
receiving modifications and updates to the subject-descriptive data via the API from the user.

7. The computer-implemented method of claim 1, further comprising transmitting to the authorized entity a link to a network location to access the subject-descriptive data, wherein the link is configured to expire within a predetermined time period.

8. The computer-implemented method of claim 1, further comprising:
receiving the subject-descriptive data from a particular user
logging access by the authorized entity to the subject-descriptive data to generate an access history log; and
providing the access history log to the particular user.

9. The computer-implemented method of claim 1, further comprising:
receiving from the authorized entity the request to provide the subject-descriptive data to the authorized entity; and
enabling a search by the authorized entity of the subject-descriptive data associated with the subject.

10. The computer-implemented method of claim 1, further comprising:
receiving from the authorized entity the request to provide the subject-descriptive data to the authorized entity; and
enabling a search by the authorized entity of the subject-descriptive data associated with the subject, wherein the search is based on at least one of a name, a telephone number and an email address of the subject.

11. The computer-implemented method of claim 1, further comprising:
receiving at least one of the subject-descriptive data, authorized entity indication, and access preference indication from a user; and
receiving the request to provide the subject-descriptive data to the authorized entity from the user, wherein the user is a different entity than the authorized entity.

12. The computer-implemented method of claim 1, further comprising:
determining if the request originates from at least one of a predetermined authorized machine system and a predetermined authorized IP address; and
providing the subject-descriptive data to the authorized entity in response to the request originating from at least one of the authorized machine system and the authorized IP address.

13. The computer-implemented method of claim 1, further comprising:
receiving credentials with the request;
determining if the credentials originate from the authorized entity;
determining if the request originates from at least one of a predetermined authorized machine system and a predetermined authorized IP address; and
providing the subject-descriptive data to the authorized entity in response to the credentials originating from the authorized entity and the request originating from at least one of the authorized machine system and the authorized IP address.

14. The computer-implemented method of claim 13, further comprising for a particular set of credentials, providing access to the authorized entity for a predetermined period of time.

15. The computer-implemented method of claim 1, wherein the authorized entity comprises a government-sponsored Public Safety Access Point (“PSAP”), the method further comprising:
determining if the request originates from at least one of a system associated with the PSAP and an IP address associated with PSAP; and
providing the subject-descriptive data to the PSAP in response to the request originating from at least one of the system associated with the PSAP and the IP address associated with PSAP.

16. The computer-implemented method of claim 1, further comprising:
receiving the subject-descriptive data and the access preference indication from a user;
receiving a request from an unauthorized entity for the subject-descriptive data;
providing an indication of the request from the unauthorized entity to the user; and
receiving the indication of the authorized entity as an indication from the user of an authorization of the unauthorized entity to receive the subject-descriptive data, converting the unauthorized entity to the authorized entity to which the subject-descriptive data is transmitted.

17. The computer-implemented method of claim 16, further comprising providing the subject-descriptive data to the authorized entity in the form of access to the subject-descriptive data for a predetermined period of time.

18. The computer-implemented method of claim 16, further comprising:
generating an identification code associated with the subject;
providing the generated identification code to the user for attachment to the subject; and
receiving the request from the unauthorized entity with the identification code associated with the subject.

19. The computer-implemented method of claim 1, further comprising:
generating an identification code associated with the subject;
providing the generated identification code to a supervising user for attachment to the subject; and
receiving the request from the authorized entity with the identification code associated with the subject;
authenticating the identification code; and
providing the subject-descriptive data to the authorized entity further in response to the authentication of the identification code.

20. The computer-implemented method of claim 19, further comprising receiving the request from the authorized entity with the identification code via an RFID device.

21. The computer-implemented method of claim 1, further comprising providing at least one API for receiving the subject-descriptive data, the indication of an authorized entity, the access preference indication, and the request to provide the subject-descriptive data.

22. The computer-implemented method of claim 1, further comprising:
receiving at least one of the subject-descriptive data, authorized entity indication, and access preference indication from a user;
receiving a request from the user to provide the subject-descriptive data, wherein the user is a different entity than the authorized entity
providing the subject-descriptive data to the user.

23. The computer-implemented method of claim 22, wherein providing the subject-descriptive data to the user comprises providing the subject-descriptive data to a supervising user having supervisory responsibility over the subject.

24. The computer-implemented method of claim 22, further comprising:
associating an emergency situation with the authorized entity;
receiving the request to provide the subject-descriptive data to the authorized entity as an indication of the emergency situation; and
providing the subject-descriptive data to the authorized entity associated with the emergency situation.

25. The computer-implemented method of claim 22, further comprising:
associating an emergency situation with an access preference;
receiving the request to provide the subject-descriptive data to the authorized entity as an indication of the emergency situation; and
providing the subject-descriptive data corresponding to the access preference associated with the emergency situation to the authorized entity.

26. A computer-implemented profile distribution method comprising:
receiving subject-descriptive data associated with a subject;
generating an identification code associated with the subject;
providing the generated identification code to a user for attachment to the subject;
receiving a request including the identification code from an entity; and
providing the subject-descriptive data to the entity in response to receiving the request including the identification code.

27. The computer-implemented method of claim 26, further comprising:
receiving an authorization to provide the subject-descriptive data to the entity; and
providing the subject-descriptive data to the entity further in response to receiving the authorization.

28. The computer-implemented method of claim 26, further comprising:
receiving the subject-descriptive data associated with a subject from a user;
receiving an authorization from the user to provide the subject-descriptive data to the entity; and
providing the subject-descriptive data to the entity further in response to receiving the authorization from the user.

29. The computer-implemented method of claim 26, further comprising providing the generated identification code to the user for attachment to the subject in the form of at least one of an RFID code and a visible code.

30. The computer-implemented method of claim 26, further comprising receiving the request from the entity comprising at least one of a school administrator, an emergency medical responder, police, and a good Samaritan.

31. A profile distribution system comprising at least one computing device including at least one memory comprising instructions operable to enable the computing device to perform a procedure comprising:
receiving subject-descriptive data associated with a subject and storing the subject-descriptive data;
receiving an indication of an authorized entity authorized to receive the subject-descriptive data;
receiving an access preference indication which defines a permission to access to the subject-descriptive data by the authorized entity;
receiving a request to provide the subject-descriptive data to the authorized entity; and
providing the subject-descriptive data to the authorized entity in response to the request consistent with the access preference indication.

32. Non-transitory computer-readable media tangibly embodying a program of instructions executable by a computing device to implement a method, the computing device being capable of interfacing with a communications network, the method comprising:
receiving subject-descriptive data associated with a subject and storing the subject-descriptive data;
receiving an indication of an authorized entity authorized to receive the subject-descriptive data;
receiving an access preference indication which defines a permission to access to the subject-descriptive data by the authorized entity;
receiving a request to provide the subject-descriptive data to the authorized entity; and
providing the subject-descriptive data to the authorized entity in response to the request consistent with the access preference indication.
